(19) United States
(12) Patent Application Publication
(10) Pub. No.: US 2026/0170975 A1
(43) Pub. Date: Jun. 18, 2026

(54) CATHETER SIMULATOR AND HEART MODEL

(71) Applicants: The University of Osaka, Suita-shi Osaka (JP); JMC CORPORATION, Yokohama-shi Kanagawa (JP)

(72) Inventors: Keita OKAYAMA, Suita-shi Osaka (JP); Yasushi SAKATA, Suita-shi Osaka (JP); Daichi WATANABE, Yokohama-shi Kanagawa (JP); Makoto INADA, Yokohama-shi Kanagawa (JP)

(73) Assignees: The University of Osaka, Suita-shi Osaka (JP); JMC CORPORATION, Yokohama-shi Kanagawa (JP)

(21) Appl. No.: 19/530,599

(22) Filed: Feb. 5, 2026

Related U.S. Application Data
(63) Continuation of application No. PCT/JP2025/017700, filed on May 15, 2025.

(30) Foreign Application Priority Data
May 17, 2024 (JP) 2024-081232

(51) Int. Cl. G09B 23/30; G09B 23/34

(52) U.S. Cl. CPC G09B 23/303; G09B 23/34

(57) ABSTRACT

A catheter simulator includes: a container filled with a liquid; a heart model installed in the container in a state of being filled with a liquid, the heart model including outer walls and a septum; and a pulsatile pump connected to the heart model and generating a pulsatile flow in the internal space of the heart model, wherein in the heart model, an area to be changed by the pulsatile flow is thin-walled compared to other areas, and a space including the thin-walled area is formed in a substantially closed shape.

### CROSS-REFERENCE TO RELATED APPLICATIONS

The present application is a continuation application under 35 U.S.C. 111(a) of International Application No. PCT/JP2025/017700, filed May 15, 2025, and designated the U.S., which claims priority from Japanese Patent Application No. 2024-081232, filed May 17, 2024, the entire contents of each are incorporated herein by reference.

### TECHNICAL FIELD

The present specification discloses a catheter simulator and a heart model used in this catheter simulator.

### BACKGROUND ART

In cardiac catheterization, there are available catheter maneuvers for tissues in charge of the structure of the heart, such as an atrial septum and a ventricular septum. An example thereof is a maneuver called atrial septal puncture, which is performed when approaching the left atrium from the right atrium. This maneuver involves inserting a catheter into the right atrium and piercing or cauterizing a needle into the atrial septum between the right atrium and the left atrium to open a hole. In this maneuver, the place of puncture varies depending on the patient's disease or the maneuver performed on that illness, and when a different location of the heart is punctured due to incorrect manipulation, complications such as causing cardiac tamponade or puncturing the esophagus, which is a tissue around the heart, may occur. Furthermore, even if the atrial septum could be punctured correctly, the success rate of subsequent maneuvers is greatly affected by whether the place to be punctured is appropriate.

As another example, there is available a catheter treatment of closing a hole against a state in which a hole is congenitally opened in the atrial septum (atrial septal defect), a state in a hole is opened in the ventricular septum (ventricular septal defect), or a state in which a hole is opened in the atrial septum or the ventricular septum in association with a surgical maneuver. In this maneuver, the hole is closed by inserting a catheter into the right atrium or the right ventricle, inserting a catheter loaded with an occlusion plug called plog into the atrial septum between the right atrium and the left atrium or the ventricular septum between the right ventricle and the left ventricle, and placing the plug in the hole in the septum. Since this maneuver is performed in a state in which the heart is beating, precise catheter manipulation is required under conditions in which the atrial septum or the ventricular septum moves due to the blood flow or the intracardiac pressure. As with the atrial septal puncture, erroneous manipulation may result in damage to another location in the heart, causing cardiac tamponade, or the plug to be placed may come off at a place that is not an intended location and drift in a cardiac chamber or a blood vessel. In addition, as a similar case, the placement of a pacemaker lead or a leadless pacemaker is available. These maneuvers do not involve placing a plug in a state in which a hole is congenitally opened in the septum; however, the maneuvers are performed in a state in which the heart is beating when a lead or a pacemaker main body is placed in the atrial septum or the ventricular septum. Therefore, the maneuvers are similar to the catheter treatment for closing a hole, from the viewpoint that in-depth catheter manipulation is required under conditions in which the atrial septum or the ventricular septum moves due to the blood flow or the intracardiac pressure.

In order to prevent the above-described complications and to realize puncture to an appropriate location according to the maneuver, training of manipulations by simulation is important. The inventors of the present disclosure have proposed, in order to promote improvement of catheter maneuvers for various heart diseases, a plurality of heart models according to the types of the heart diseases, and a simulator including a container for holding each heart model and a pump for circulating a stream of water in the container (for example, Patent Documents 1 and 2). These patent documents disclose catheter simulators and heart models that allow practicing maneuvers similar to actual surgeries for various cardiac diseases, by storing water in a small container to float a heart model therein, creating a flow into the heart with the pump to generate a pulsatile flow, inserting a catheter into the floating heart model, and manipulating the catheter.

### CITATION LIST

### Patent Document

Patent Document 1: JP 7251746 B

Patent Document 2: JP 7401867 B

### SUMMARY

### Problem to be Solved

Currently, in cardiac catheterization, no catheter simulator has been proposed for training cardiac catheter maneuvers such as atrial septal puncture, atrial septal closure, or ventricular septal closure, while using imaging devices that are used as guides in actual clinical practice, such as X-ray fluoroscopy and ultrasound, under conditions in which tissues in charge of the structure of the heart, such as atrial septum and ventricular septum, move due to the flow or pressure caused by pulsation. In actual clinical practice, the atrial septum and the ventricular septum are known to move due to autonomous contraction and expansion, pressure inside the cardiac chambers, or blood flow, and reproducing this movement and blood flow is important for promoting improvement of a maneuver through a simulation.

The present inventors performed the above-described maneuvers using a related catheter simulator and a heart model and found that the movement of components of the actual heart (outer walls, septa, and the like) could not be accurately reproduced, and there was still room for further improvement. That is, in related catheter simulators, the pressure inside the cardiac chambers or the blood flow is not taken into consideration in the heart model to be installed, and therefore, the actual movement of the heart is not accurately reproduced.

In the present specification, it is an object of the disclosure to provide a catheter simulator that can promote improvement of maneuvers in catheter maneuvers for tissues in charge of the structure of the heart, which are mainly performed in arrhythmia diseases and structural heart diseases, and a heart model that is installed in such a catheter simulator.

### Means for Solving Problem

The catheter simulator disclosed in the present specification includes: a container filled with a liquid; a heart model installed in the container in a state of being filled with a liquid, the heart model including outer walls and a septum; and a pulsatile pump connected to the heart model and generating a pulsatile flow in an internal space of the heart model. Further, the heart model is such that an area to be changed by the pulsatile flow is thin-walled compared to other areas, and a space including the thin-walled area is formed in a substantially closed shape.

In the catheter simulator configured as described above, the pulsatile pump generates a pulsatile flow in the heart model. In the heart model, an area to be changed by the pulsatile flow is thin-walled, compared to other areas. Since a space including this thin-walled area is formed in a substantially closed shape, when a pulsatile flow is discharged (introduced) into and suctioned into the heart model using a pulsatile pump, vibrations similar to those of the actual heart repeatedly occur at the thin-walled area. Therefore, it is possible to perform a simulation that is in line with the movement of the actual heart.

Furthermore, the heart model disclosed in the present specification is formed from a flexible material and includes outer walls constituting a right atrium and a left atrium, and an atrial septum dividing these, or outer walls constituting a right ventricle and a left ventricle, and a ventricular septum dividing these. Further, the heart model is such that one or more of the right atrium, the left atrium, the right ventricle, and the left ventricle is formed in a substantially closed space, and a portion of the structural part constituting the substantially closed space is configured to be thinner compared to other structural parts.

According to the heart model configured as described above, when the heart model is floated in a container storing a liquid and is connected to a pulsatile pump, vibrations similar to those of the actual heart can be made to occur repeatedly in the thin-walled part in the substantially closed space.

### Effect

According to the catheter simulator and the heart model in the present specification, improvement of catheter maneuvers for tissues in charge of the structure of the heart in cardiac catheterization, which are mainly performed for arrhythmia diseases, structural diseases, and the like, such as atrial septal puncture, atrial septal closure, ventricular septal closure, and placement of pacemaker lead or main body, can be promoted.

### BRIEF DESCRIPTION OF DRAWINGS

FIG. 1 is a diagram illustrating an embodiment of a catheter simulator;

FIG. 2 is a diagram illustrating a container portion of the catheter simulator shown in FIG. 1 as viewed from above;

FIG. 3 is a perspective view illustrating the container portion of the catheter simulator shown in FIG. 1 as viewed from the front;

FIG. 4 is a perspective view illustrating the container portion of the catheter simulator shown in FIG. 1 as viewed from the rear;

FIG. 5 is a schematic view illustrating a general structure of the heart;

FIG. 6 is a diagram illustrating an embodiment of a heart model and illustrating a state in which the outer walls constituting the right atrium have been removed to expose the atrial septum;

FIG. 7 is a cross-sectional view of the heart model;

FIG. 8 is a diagram illustrating a state in which a thin film member that is attachable and detachable is attached to the atrial septum;

FIG. 9 is a plan view illustrating a state in which the heart model shown in FIG. 8 is set inside the container;

FIG. 10 is a perspective view of a holder holding the thin film member as viewed from the back side;

FIG. 11 is a perspective view of the holder holding the thin film member as viewed from the front side; and

FIG. 12 is a perspective view of the holder holding the thin film member as viewed from another angle on the back side.

### DETAILED DESCRIPTION

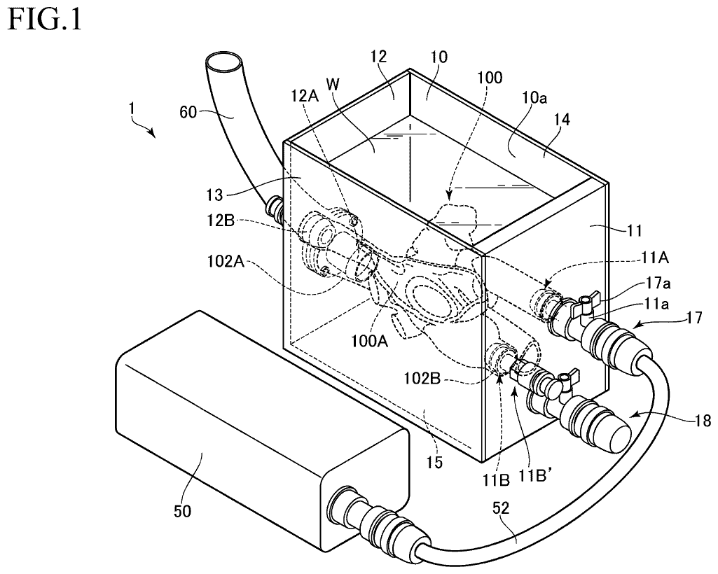

FIG. 1 is a diagram showing a catheter simulator and a heart model for atrial septal puncture, which is an embodiment of a heart model used in the catheter simulator.

The catheter simulator according to the present embodiment is configured to be suitable for practicing a maneuver of mainly feeding a catheter to the right atrium through the inferior vena cava, puncturing the atrial septum to form a hole, and introducing the catheter into the left atrium side.

The catheter simulator 1 shown in FIG. 1 includes a container 10 that houses a heart model 100, and a pulsatile flow generating pump (hereinafter, referred to as pump) 50 that circulates a liquid W such as water in a state in which the container 10 is filled with the liquid. The container 10 holds the heart model 100 such that the heart model 100 floats in the liquid W, and as the pump 50 repeats a suction operation and a discharge operation in a space formed to be in a closed shape (substantially closed shape), the right atrium and the left atrium in the heart repeatedly undergo expansion and contraction as will be described below.

The heart model 100 is formed from a material having flexibility close to that of the heart of an actual human body, for example, PVA (polyvinyl alcohol), polyurethane, epoxy resin, unsaturated polyester, phenol resin, silicone, materials similar to these, and other thermosetting resins and thermoplastic resins, which are used either singly or in combination of a plurality of the materials, so that catheter manipulation can be practiced with a tactile sensation close to that of human organs.

As will be described below, the heart model 100 has a structure suitable for a maneuver in which a catheter is introduced through the superior vena cava or the inferior vena cava, a hole is formed in the atrial septum from the right atrium, and the catheter is introduced into the left atrium side. With regard to the color of the heart model 100, the inner part may be made visually not recognizable by adopting the same color as that of the actual heart, so that the trainee can perform a simulation while observing a monitor displaying an X-ray fluoroscopic image or an ultrasound image. Alternatively, the heart model 100 may be made to have a transparent or translucent color so that the trainee can perform a simulation while directly observing the movement of a catheter, a guide wire, and other devices to be inserted, by visual inspection. Incidentally, even though the trainee forms a heart model with a material that is visually recognizable, when the container 10 is covered with a cover or the like so as to make the heart model not visible to the trainee, it is also possible to grasp the behavior of the catheter only through an X-ray fluoroscopic image or an ultrasound image on the monitor.

It is preferable that the heart model 100 is integrally formed without any artificial seams. As a result, the occurrence of a flow of a liquid (blood flow) that is not seen in the human body due to seams can be prevented. Furthermore, obstruction of the visual field by seams during catheter insertion can be prevented, and in addition, the appearance of unnatural shadows under X-ray fluoroscopy can be avoided. As a method for forming a heart model using a material that satisfies properties such as described above, for example, it is possible to use an optical shaping method. When the shaping method is used, a highly accurate heart model for each patient can be formed at relatively low cost in a short period of time, based on the imaging data of a human organ (cardiac CT data). For this reason, it is possible for the trainee to produce a patient-specific heart model and receive simulation training for catheter manipulation, in advance of actual surgery. Furthermore, it is also possible to utilize a catheter simulator as a preliminary preparation prior to actual catheter manipulation, such as selecting and examining a catheter and various devices optimal for the patient before an examination or a surgery.

When the heart model 100 is formed according to the above-described optical shaping method, since a state close to the human body can be reproduced, the surface of the heart model is not smooth and includes fine surface unevenness similar to that of the human body. In this case, even when the heart model is formed using a transparent or translucent material such as described above, since visible light is diffusely reflected on the surface having surface unevenness, visibility may deteriorate. In that case, after the heart model is formed, diffuse reflection can be reduced by coating the surface with the same material to smoothen the surface having surface unevenness, and visibility can be improved.

Furthermore, the catheter simulator 1 using the heart model 100 of the present embodiment repeats discharge of a liquid into the main body 100A of the heart model 100 and suction of the liquid using the pump 50 to generate a flow inside the heart model 100. For this reason, the main body 100A having elasticity, specifically, the left atrium and the right atrium, repeatedly undergo expansion (positive pressure) and contraction (negative pressure) to cause the liquid to flow in the same manner as the blood flow in the actual heart. By repeating discharge and suction of a liquid in this way, in a simulation utilizing a contrast medium, it is possible to grasp the behavior of the catheter on the monitor by suppressing the contrast medium from staying inside the heart.

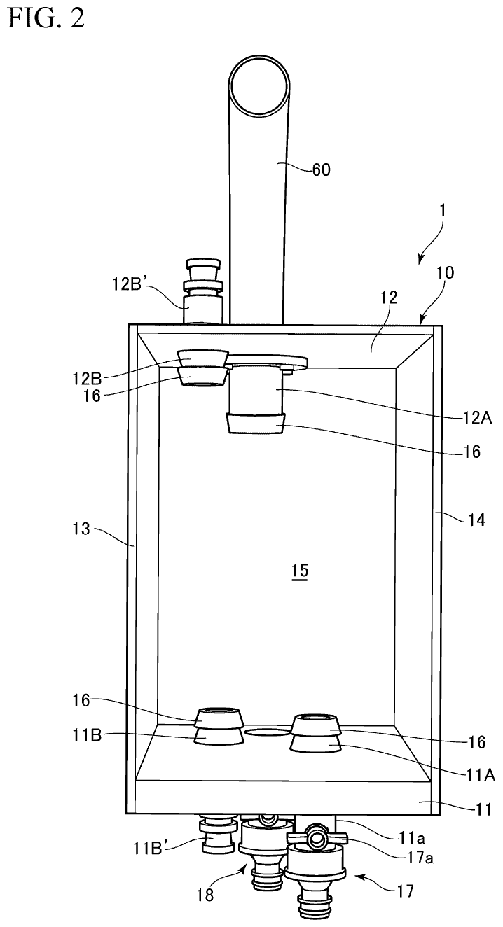

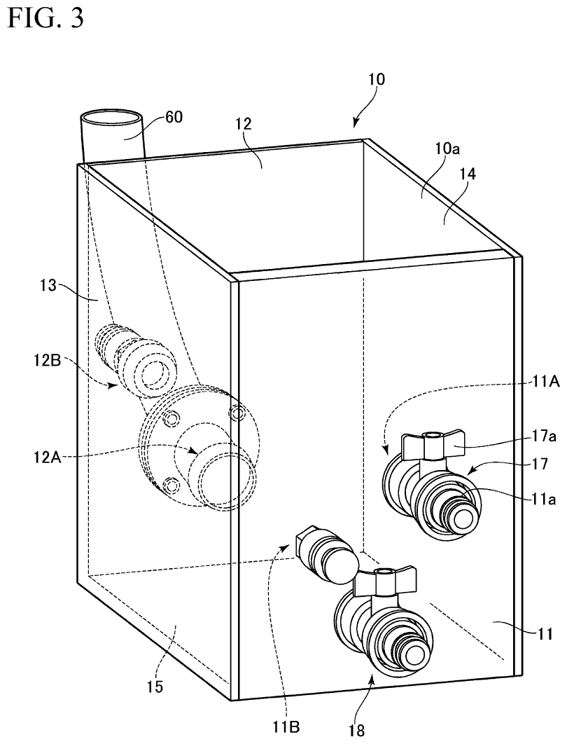

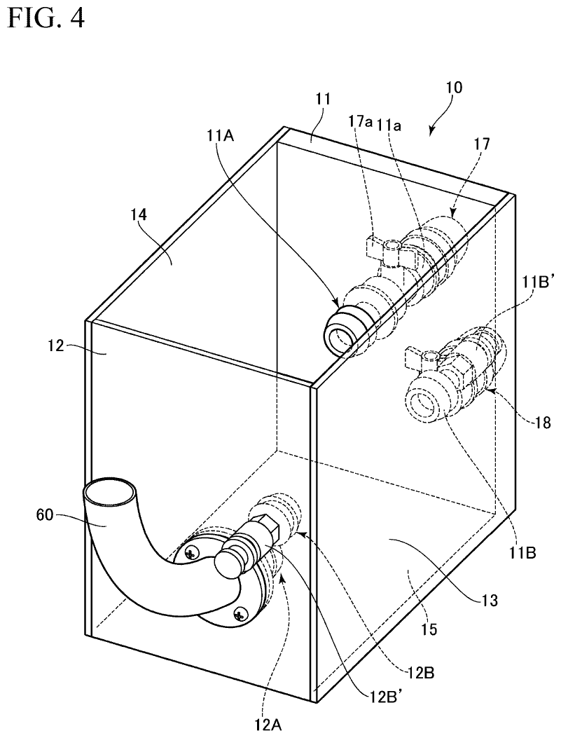

Next, the container 10, the pump 50, and the heart model 100 will be described with reference to FIG. 1 through FIG. 4 and FIG. 9.

Note that the heart model 100 of the present embodiment is formed to have a structure appropriate for simulation (a structure different from the actual heart), such as by omitting several elements constituting the heart and adding a holding part that is absent in the actual heart. The specific structure of the heart model of the present embodiment will be described below.

The container 10 according to the present embodiment includes an accommodation part 10a that accommodates a liquid W such as water or an aqueous electrolyte by means of side walls 11 to 14 of four sides and a bottom face 15. In this case, the side wall 11 corresponds to the leg side of the actual human body, and the side wall 12 corresponds to the head side of the actual human body.

On the side wall 11 and the side wall 12, holding parts 11A and 11B and holding parts 12A and 12B are formed, which are capable of holding the heart model 100 in a state in which the accommodation part 10a is filled with a liquid.

These holding parts are provided so as to protrude into the accommodation part 10a and are formed, for example, in a cylindrical shape. When the holding parts are formed in a cylindrical shape, cylindrical parts formed in the heart model 100 (in the present embodiment, superior and inferior venae cavae, the esophagus, and cylindrical-shaped connecting portions that do not exist in the actual heart) can be plugged into the holding parts, and the heart model 100 is held in a state of floating inside the container 10 filled with a liquid.

In this case, it is preferable that in each of the holding parts 11A and 11B and the holding parts 12A and 12B, one or more flanges 16 whose diameters decrease toward the tip are formed on the outer peripheral surface of the holding part. As a result, when the heart model 100 is installed, it is possible to hold the heart model 100 stably by making the connecting portions difficult to come off.

In the present embodiment, the holding parts 11B and 12B also function as introduction parts through which a catheter is inserted, and a vena cava (superior vena cava 102A or inferior vena cava 102B) of the heart model 100 is to be plugged and held in each of the holding parts. For this reason, in each of the holding parts 11B and 12B, an introduction part 11B′ or 12B′ that coaxially protrudes to the outside of the container is integrally formed, and an introduction tube of a catheter (not shown in the diagram) is to be connected to each of the introduction parts.

A connection part 123 linked to the left atrium 120 of the heart model 100 is connected to the holding part 11A. This connection part 123 is a constituent member that does not exist in the actual heart, and when a suction-discharge pipe 52 of the pump 50 is connected to a tube part 11a protruding to the outside on the same axis as the holding part 11A, a flow of liquid occurs in the left atrium 120, so that the left atrium 120 repeatedly undergoes expansion and contraction.

It is preferable that the tube part 11a protruding to the outside of the container is provided with a connection mechanism 17 and is configured such that the suction-discharge pipe 52 of the pump 50 can be attached to and detached from the tube part 11a through a one-touch operation. Furthermore, it is preferable that an on-off valve (not shown in the diagram) is provided in the flow path of this connection mechanism 17, and that the connection mechanism 17 is configured such that the liquid does not leak out by manipulating an on-off manipulation member 17a. As a result, the liquid inside the accommodation part can be prevented from leaking when the suction-discharge pipe 52 is attached or detached.

Incidentally, the side wall 11 may be provided with a connection mechanism 18 that is connected to the internal space of the container. This connection mechanism 18 is not used in the simulation of the present embodiment; however, in a case where a different heart model is mounted or the like, the connection mechanism 18 can be connected to the pump 50 to circulate the liquid inside the heart model or to function as a drainpipe to drain the liquid collected in the container 10.

The holding part 12A provided on the side wall 12 is provided to allow transesophageal echocardiography to be performed. Transesophageal echocardiography is used to introduce an ultrasound probe into the esophagus and observe the heart from the inside. For this reason, in the main body 100A of the heart model 100 of the present embodiment, an esophagus 105 through which an ultrasound probe for performing transesophageal echocardiography can be inserted is formed adjacent to the vena cava (superior vena cava 102A or inferior vena cava 102B) (in contact with the back surface of the heart model).

This esophagus 105 is in a state in which one end 105a is plugged into the holding part 12A and held therein, while the other end 105b is opened inside the container. Furthermore, a tubular-shaped part 60 into which an ultrasound probe is inserted toward the inside of the accommodation part, is provided on the outer side of the holding part 12A from the container. That is, since X-ray fluoroscopy, intracardiac ultrasound, transesophageal ultrasound and the like are used when puncturing the atrial septum, it is preferable that a port for introducing transesophageal ultrasound is integrally formed.

The above-described side walls 11 to 14 and the bottom face 15 of the container 10 only need to be formed using a material with a strength capable of stably accommodating the liquid and the heart model. The container 10 may be formed into a shape that can stably accommodate the liquid and the heart model. Furthermore, it is preferable that the material of the side walls 11 to 14 and the bottom face 15 constituting the container has transparency. As the side walls and the bottom face have transparency, it is possible to observe the behavior of the heart model installed inside the container 10, or the behavior of a catheter or the like to be inserted from the outside of the container 10, by visual inspection during a simulation. Examples of a transparent material having such strength include acryl, polycarbonate, PET, and polystyrene.

Incidentally, even in a case where the container 10 is formed from a material that can be visually recognized by the trainee, when a camera is installed to display the data on a monitor or the like, or when X-ray fluoroscopy is performed to display the data on a monitor or the like, a simulation for grasping the behavior of the catheter only on the monitor can be performed, and it is also possible to realize a state closer to the reality. Depending on the stage and content of the training, visual recognition with naked eyes, monitor display checking, or use of X-ray imaging can be selected.

The upper part of the container 10 is opened, and a lid that is openable or closeable may be disposed thereon. As a result, when doing preparation for practice or cleanup, such as an operation of filling the accommodation part 10a with the liquid W, or an operation of installing a heart model in the liquid, the operations can be efficiently carried out through the opening at the top face of the container. Furthermore, by making the lid transparent, dust can be prevented from entering. In addition, it is also possible to prevent deterioration of visibility caused by shaking of the liquid surface, by bringing the lid into close contact with the liquid surface.

The holding parts 11B and 12B have a function as introduction parts for a catheter, in addition to a function of holding the heart model. As described above, an introduction tube for introducing a catheter to be manipulated by a trainee from the outside of the container 10 is connected to each of the introduction parts 11B′ and 12B′, which protrude to the outside coaxially with the holding parts 11B and 12B.

In an actual simulation, the accommodation part 10a is filled with the liquid W, and the heart model 100 is installed in a state of floating in the liquid. When the heart model 100 is in a floating state, the trainee can obtain a feeling of touch closer to reality during catheter manipulation. Incidentally, in addition to the above-described holding parts, for example, a dedicated holder may be installed at the bottom face of the container so as to support the heart model 100 from below and hold the heart model 100 in the liquid.

Since the elements accommodated in the container 10 are limited only to a heart model 100 having the same size as that of the human heart and a liquid W allowing the heart model to float therein, the container 10 can be miniaturized. The external dimensions of the container 10 according to the present embodiment are about 20 cm×20 cm×15 cm, and the amount of the liquid (water) required for filling the container is approximately limited to about 3 L to 6 L. When the container 10 is miniaturized, waste of space in the place where the simulation is performed can be eliminated, and the storability and transportability of the container 10 and the catheter simulator using the container 10 can be improved. Furthermore, since the amount of water to be filled in the accommodation part 10a of the container is limited to about 6 L, even at a place where tap water cannot be utilized, simulation can be performed by transporting water in a tank or the like, and the range of selection for the place of implementation is broadened. In addition, since the weight of the container filled with water is so light that the trainee can handle the container alone, preparation and cleanup of the simulation can be easily carried out without the constraints of an assistant.

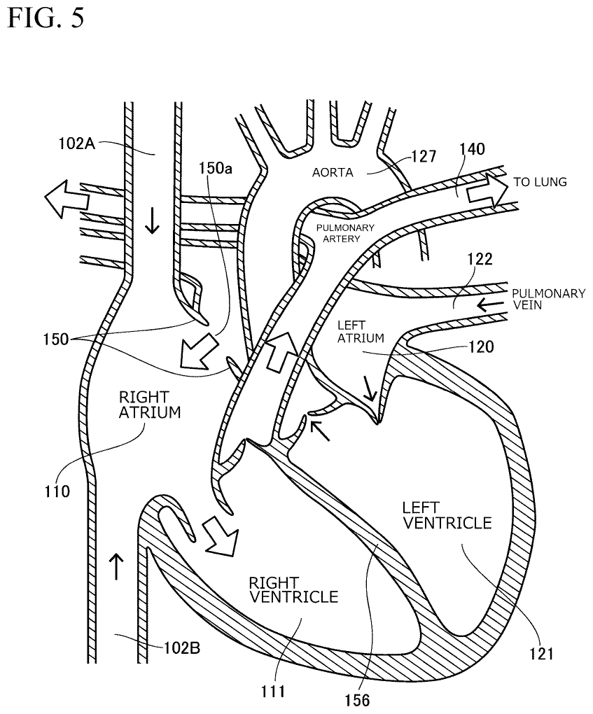

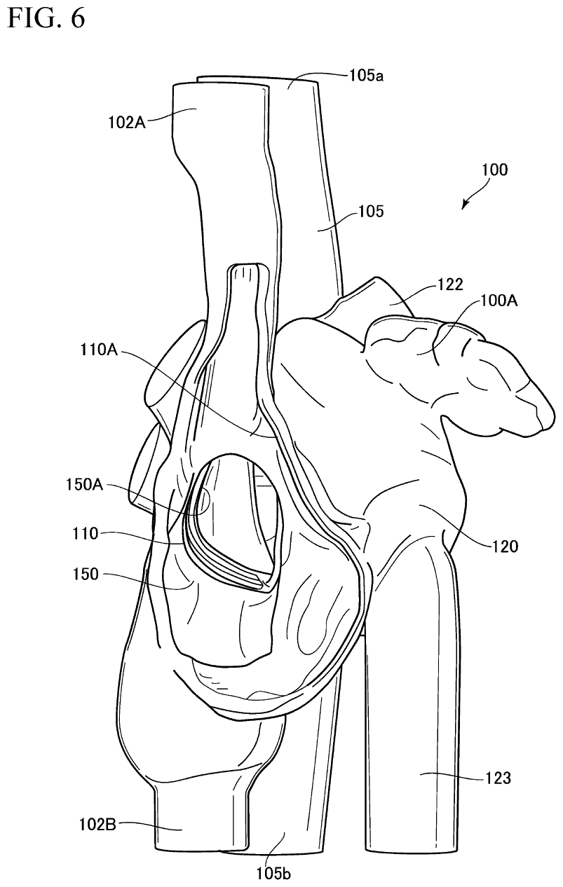

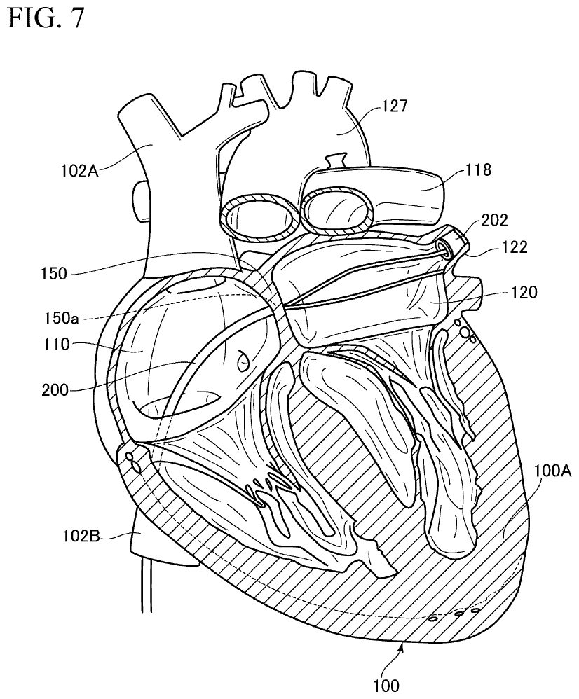

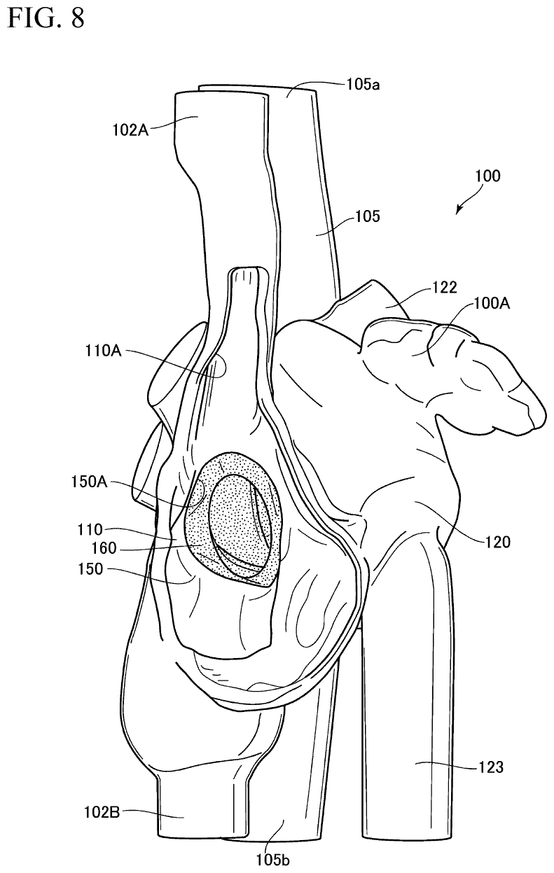

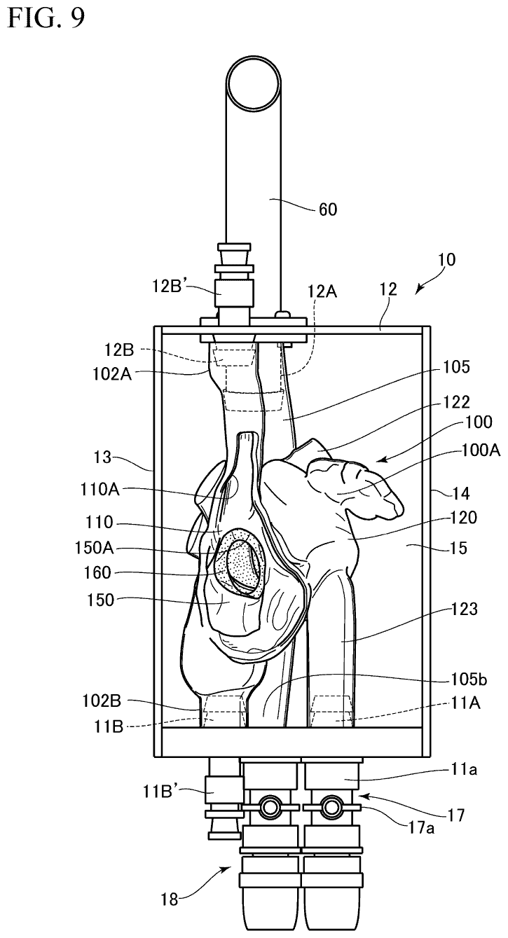

Next, a specific configuration of the heart model 100 according to the present embodiment will be described with reference to FIG. 5 through FIG. 9. In these figures, FIG. 5 is a schematic view illustrating a general structure of the heart, FIG. 6 is a diagram illustrating the heart model of the present embodiment and illustrating a state in which the outer walls constituting the right atrium (right ventricle) have been removed to expose the atrial septum, FIG. 7 is a cross-sectional view of the heart model, FIG. 8 is a diagram illustrating a state in which a thin film member that is attachable and detachable is attached to the atrium septum, and FIG. 9 is a plan view illustrating a state in which the heart model shown in FIG. 8 is set inside the container.

Incidentally, since the heart model only needs to include the minimum constituent elements necessary for catheter manipulation, the main body 100A of the heart model 100 of the present embodiment has a structure different from that shown in the schematic view of FIG. 5. However, on the occasion of explaining the heart model of the present embodiment, the schematic view of FIG. 5 will be used for the explanation to make the constituent elements easier to understand.

As shown in FIG. 5, the inside of the main body of the actual heart includes four chambers, namely, a right atrium 110, a right ventricle 111, a left atrium 120, and a left ventricle 121. Venae cavae (superior vena cava 102A and inferior vena cava 102B) protrude from the right atrium 110, and a pulmonary artery 140 protrudes from the right ventricle 111. The inferior vena cava 102B of the heart model of the present embodiment is connected to the holding part 11B (introduction part 11B′) formed in the container 10 and serves as an introduction port for a catheter. Furthermore, the superior vena cava 102A of the heart model is connected to the holding part 12B (introduction part 12B′) formed in the container 10 and serves as an introduction port for a catheter.

In the actual human body, the inferior vena cava 102B reaches the femoral vein running through the groin and serves as an introduction path for a catheter that is introduced through the groin (base of the legs). Furthermore, the superior vena cava 102A reaches the integral jugular vein running through the base of the neck and serves as an introduction path for a catheter that is introduced through the base of the neck.

The heart model of the present embodiment includes outer walls constituting the right atrium 110 and the left atrium 120 and an atrial septum 150 dividing these atria, or outer walls constituting the right ventricle 111 and the left ventricle 121 and a ventricular septum 156 separating these ventricles. That is, the main body 100A includes a right atrium 110 and a left atrium 120 separated by an atrial septum 150 to be adjacent to each other and includes a right ventricle 111 and a left ventricle 121 separated by a ventricular septum 156 to be adjacent to each other.

In this case, one or more of the right atrium 110, the left atrium 120, the right ventricle 111, and the left ventricle 121 are formed in a substantially closed space, and a portion of the structural part constituting the substantially closed space is configured to be thinner compared with other structural parts.

Here, as will be described below, a “substantially closed space” means that when suction and discharge of a liquid is repeatedly carried out using the pump 50, it is desirable that the thinned portion within the space can vibrate, and as long as such vibrations can be obtained, the main body 100A may have a partially open area.

In the present embodiment, for example, when performing atrial septal puncture on the occasion of catheterization for atrial fibrillation, the structure is suitable for vibrating the atrial septum 150 (see FIG. 7) in which a hole has been formed by a needle part of a catheter 200 introduced from the right atrium 110.

In actual treatment, a catheter is introduced into the left atrium 120 through a formed hole 150a, and for example, a simulation of electrotherapy by radiofrequency catheter ablation or cooling therapy by a cryoballoon ablation catheter is performed on the joint part of the left atrium 120 and the pulmonary vein 122. In this case, as shown in FIG. 7, the catheter 200 to be manipulated is introduced into the right atrium 110 through the inferior vena cava 102B, punctures the atrial septum 150, and then is introduced into the left atrium 120 side.

On the occasion of performing the above-described atrial septal puncture, the portion that is formed thinner compared to other structural parts is the atrial septum 150. In a simulation of puncturing the atrial septum 150, it is important that the heart model behaves in the same manner as the actual heart. That is, in actual clinical practice, it is known that the atrial septum moves (vibrates in a direction approximately perpendicular to the atrial septum) due to the pressure in the cardiac chambers and the blood flow, and it is important to reproduce such movement and blood flow even in a simulation using a heart model.

In this case, it is possible to ensure a certain degree of reproducibility even in a method of connecting the right atrium side to the pump 50 to discharge the liquid into the heart model, and suctioning the discharged liquid from another area, as in related heart models and simulators. On the other hand, the heart of an actual living organism ejects blood to various locations by repeating autonomous contraction and expansion, rather than by passive movement caused by a pump. Therefore, even if a heart model that has been condensed to the same thickness as that of the heart of a living organism is created, the heart model cannot be made to undergo expansion and contraction as intended, due to the external action brought by the suction operation and the discharge operation of the pump 50.

However, in the heart model, by forming an area where expansion and contraction is desired, to be relatively thinner than other areas, and configuring the area to be a closed circuit or a semi-closed circuit (forming a closed space or a semi-closed space and repeatedly performing suction and discharge of a liquid within that space), the intended area can be subjected to expansion and contraction through the action of the pump.

Therefore, in order to realize an operation of the atrial septum 150 close to that in actual clinical practice, the simulator of the present embodiment is configured as follows, so that practice can be carried out in the same manner as in actual catheterization.

When the atrial septum 150 is made thin-walled, that portion of the atrial septum 150 is more likely to vibrate compared to other areas (likely to vary (vibrate) in a direction orthogonally intersecting the atrial septum). For this reason, when the space including the atrial septum 150 is formed in a closed shape, the pump 50 shown in FIG. 1 is connected to the inside of the space, and suction of the liquid and discharge of the liquid are repeated, the left atrium 120 and the right atrium 110 repeat expansion (positive pressure) and contraction (negative pressure). Due to this expansion (positive pressure) and contraction (negative pressure), the liquid flows like the actual blood flow of the heart, and it is also possible for the atrial septum 150 to reproduce the same movement as the actual heart.

Specifically, the left atrium 120 is formed into a space with a substantially closed shape, the connection part 123 formed on the left atrium 120 side is plugged into the holding part 11A of the container 10, and the suction-discharge pipe 52 of the pump 50 is connected through the tube part 11a protruding to the outside on the same axis as the holding part 11A. The pump 50 has a simple structure that simply repeats suction of a liquid and discharge of the liquid, and repeatedly performs suction and discharge of a liquid to the left atrium 120 through the suction-discharge pipe 52.

As a result, in the left atrium 120, which is a closed space, expansion (positive pressure) associated with the discharge operation of the pump 50 and contraction (negative pressure) associated with the suction operation of the pump 50 occur continuously and repeatedly.

When the practice of catheter introduction operation is repeatedly carried out in the above-described heart model 100, the atrial septum 150 is damaged, and therefore, in the present embodiment, at least a portion of the atrial septum 150 is configured such that the portion that is punctured by a catheter 200 to be introduced is attachable and detachable.

In this way, when the area to be punctured is taken into consideration depending on the surgical technique, and only that area is configured to be attachable and detachable, the main body 100A does not have to be unnecessarily replaced. In the present embodiment, the area configured to be attachable and detachable is configured such that, as shown in FIG. 5, FIG. 6, and FIG. 8, an opening part 150A is formed in advance in the atrial septum 150, and a thin film member 160 having flexibility and thickness of the same degree as those of the actual heart can be attached and detached in that portion.

The thin film member 160 only needs to be formed from a flexible and soft material (rubber or the like) that can be punctured by the needle part of a catheter, and that material is not limited. Furthermore, it is desirable that the thin film member 160 is configured in a state in which slack is provided on the central side in order to allow the thin film member to stretch in a tent shape from the right atrium side toward the left atrium side when punctured using a catheter.

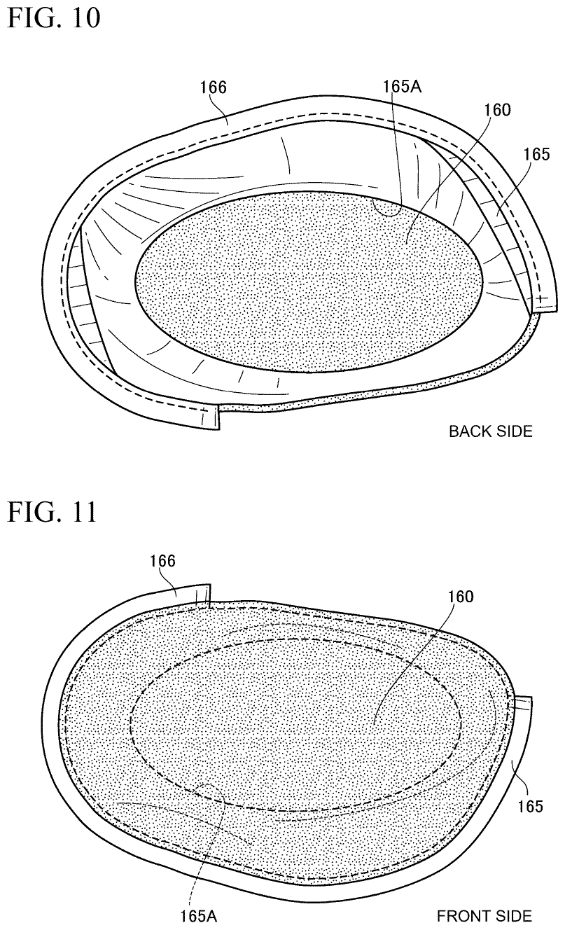

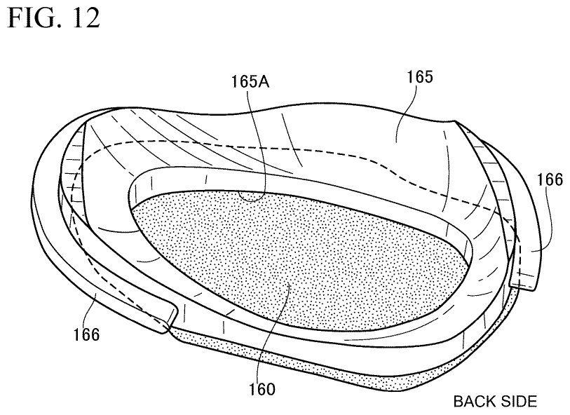

Furthermore, in the present embodiment, as shown in FIG. 10 to FIG. 12, in order to make the thin film member 160 easily handleable and to allow easy manipulation of the attachment and detachment to the atrial septum 150, the thin film member 160 is attached to a ring-shaped holder (hard frame) 165 having the same size as the size of the opening part 150A. The holder 165 is formed from a material (hard plastic or the like) having a hardness higher than that of the main body 100A (atrial septum 150), and the thin film member 160 is attached to an opening 165A formed in the central region of the holder 165 by adhesion or the like.

A step part 166 is formed in the periphery of the holder 165, and the opening part 150A of the atrial septum is closed by press-fitting the step part 166 onto the edge (inner edge) of the opening part 150A of the atrial septum 150. Alternatively, it is also possible to form an annular groove in the periphery of the holder 165 and to configure the edge of the opening part 150A of the atrial septum 150 to be fitted into this annular groove to be attachable and detachable.

In this way, by configuring the atrial septum 150 such that only the portion to be punctured can be replaced, it is possible to perform a simulation many times repeatedly. That is, in a surgical technique for puncturing the atrial septum 150, the location for piercing the catheter is important (the location for piercing varies depending on the maneuver), and it is possible to perform this surgical technique efficiently. Furthermore, since damage occurs when a simulation is performed, only a necessary area may be replaced by making the heart model in a replaceable type as described above. It is possible to perform maneuvers many times even without preparing a large number of heart models 100.

Incidentally, as described above, the replaceable portion that is attachable and detachable may be only a portion of the atrial septum, or the atrial septum itself (entirety) may be configured to be replaceable. Even if a portion of the atrial septum is formed as a replaceable thin film member 160, the atrial septum can vary (vibrate) in an orthogonal direction. That is, by connecting the pump 50 shown in FIG. 1 such that the left atrium 120 and the right atrium 110 repeat expansion (positive pressure) and contraction (negative pressure), the liquid flows like the blood flow of the actual heart, and it is also possible for the thin film member 160 to reproduce the same movement as that of the actual heart. As a result, it is possible to simulate a puncture manipulation with a catheter in a state closer to actual practice, and it is possible to promote improvement of the maneuver.

In the above-described heart model, on the occasion of simulating a maneuver of puncturing the catheter 200 into the atrial septum 150 from the right atrium 110 side and introducing the catheter 200 into the left atrium 120 side, unnecessary elements of the heart model, for example, the right ventricle 111 and the left ventricle 121 may be omitted.

Alternatively, as shown in FIG. 6, the outer walls (a portion of the outer walls) constituting the right atrium 110 may be removed to form a cutout part 110A. By forming such a cutout part 110A, the area extending from the internal space of the right atrium 110 to the atrial septum 150 can be exposed, and a simulation can be performed while visually recognizing the movement of the catheter, so that it is possible to promote improvement of the maneuver.

That is, when puncturing the atrial septum 150, by forming the cutout part 110A in the outer wall portion of the atrial septum 110 in order to allow the catheter 200 to access the right atrium 110 through the inferior vena cava 102B, it is possible to visibly recognizing the movement of the catheter to be manipulated even in an environment where there are no X-rays, ultrasound, or the like.

Incidentally, it is possible to ensure visibility by forming the heart model 100 from a transparent material even without removing the outer wall portion constituting the right atrium. Furthermore, on the left atrium 120 side, an aorta 127 and a pulmonary artery 118 do not need to be formed so that a closed space is formed, and even if the aorta and the pulmonary artery are formed, their tips are closed.

As described above, the portion where the constituent elements of the heart model 100 are removed can be determined according to the surgical technique to be simulated. For example, the heart model may be shaped in a state in which all or a portion of the outer walls constituting the right atrium 110, the left atrium 120, the right ventricle 111, or the left ventricle 121 have been removed. Alternatively, the outer walls may be cut out, or an opening region may be formed, so that the atrial septum 150 or the ventricular septum 156 is exposed.

Furthermore, even if such an opening is formed, on the right atrium 110 side, contraction (negative pressure) and expansion (positive pressure), which are opposite movements, occur continuously and repeatedly due to the variation of the thin film member 160 of the atrial septum 150. For this reason, the atrial septum (thin film member 160 that is movable and has the minimum necessary size) reciprocates in directions orthogonally intersecting each other, as in the case of the actual heart.

According to the movement of the above-described thin film member 160, since the same movement as that of the atrial septum of the actual heart is reproduced, it is possible to simulate the puncture manipulation with a catheter in a state closer to the actual practice, and it is possible to promote improvement of the maneuver.

The pumps used in related simulations are configured to introduce a flow in one direction into the heart model and suction the liquid flowing out from the heart into the container, and therefore, the connection work is troublesome. On the other hand, since the pump according to the present embodiment has a structure that repeats suction and discharge through one port, it is possible to set the pump in a simple manner.

Furthermore, although the pump 50 is connected on the left atrium 120 side of the heart model 100, as long as the movement of the thin film member 160 such as described above can be realized, the pump 50 may be configured to be connected to the right atrium 110 or to a space contiguous with the left atrium 120 and the right atrium 110. In this case, it is desirable that at least one of the right atrium 110 and the left atrium 120 of the heart model 100 forms a closed circuit (meaning a configuration in which the left and right atria can continuously repeat expansion and contraction due to the liquid flowing in or being discharged) in a state in which the pump 50 is connected, or forms a semi-closed circuit in which the parts other than the atrial septum are closed in a case where an opening part is provided in a portion of the atrial septum.

Furthermore, the portion to which the pump 50 is connected may be a location other than the left atrium (left ventricle). For example, the pump 50 may be connected to the pulmonary vein 122 of the left atrium 120 to configure a closed circuit such as described above.

In the configuration of the present embodiment, the left atrium 120 is formed as a closed space (substantially closed space); however, in another embodiment, for example, in the case of atrial septal closure, a portion of the atrial septum remains open. By closing the portions other than the atrial septum, the left atrium 120 can be maintained as a semi-closed space. As a result, the behavior of the atrial septum can be maintained.

Incidentally, in the catheter simulator having the above-described configuration, the pulsatile pump 50 is configured to repeat an operation of suctioning a liquid and an operation of discharging a liquid and continuously generate a negative pressure and a positive pressure inside the right atrium and inside the left atrium. In the present embodiment, since the flow is not a unidirectional flow but is a flow going back and forth, air may accumulate inside the pump or in the connecting path connecting the pump to the container. For this reason, it is preferable to connect the pulsatile pump 50 and the container 10 and install an air discharge path that discharges accumulated air bubbles into the container 10 (for example, connected via a separate path independent from suction and discharge of the liquid, using a member such as a fine tube) in the pulsatile pump 50. As a result, it is possible to remove air efficiently. In this case, it is possible to suspend a tube from the liquid surface at the upper surface into the liquid on the container side; however, from the viewpoints of visibility and usability, it is preferable that the container is configured such that a connection port is provided on a tank side wall to allow attachment and detachment through a one-touch operation.

Embodiments of the catheter simulator and the heart model have been described above; however, the configurations proposed in the present specification are not limited to the above-described embodiments, and various modifications can be made. For example, the structure of the heart model can be appropriately modified, and it is possible to appropriately modify the holding location and holding mode for the container 10.

Furthermore, in the heart model 100, the portion that is formed thinner compared to other structural parts may be the ventricular septum. In addition, the heart model 100 may include one or more of cardiac chambers of the right atrium, the left atrium, the right ventricle, and the left ventricle.

For example, in the case of a heart model that does not have a left atrium but only has a right atrium, a thin-walled part may be formed in an area corresponding to the atrial septum among the outer walls constituting the right atrium.

Furthermore, in the case of a heart model that does not have a left ventricle but only has a right ventricle, a thin-walled part may be formed in an area corresponding to the ventricular septum among the outer walls constituting the left ventricle.

In the case of forming a heart model having a plurality of cardiac chambers, the combination of the cardiac chambers is not limited, and even the septum may be either an atrial septum or a ventricular septum, or both of them.

The pulsatile pump 50 may be connected to, for example, any of the spaces formed according to the combination of the above-described cardiac chambers, such as the right atrium or the left atrium, a space contiguous with the left atrium and the right atrium, the right ventricle or the left ventricle, or a space contiguous with the left ventricle and the right ventricle.

What is claimed is:

1. A catheter simulator comprising:
a container filled with a liquid;
a heart model installed in the container in a state of being filled with a liquid, the heart model including outer walls and a septum; and
a pulsatile pump connected to the heart model and generating a pulsatile flow in an internal space of the heart model,
wherein in the heart model, an area to be changed by the pulsatile flow is thin-walled compared to other areas, and
a space including the thin-walled area is formed in a substantially closed shape.

2. The catheter simulator according to claim 1, wherein the pulsatile pump is connected to the space formed in a substantially closed shape and repeats an operation of introducing a liquid and an operation of suctioning the introduced liquid.

3. The catheter simulator according to claim 1, wherein the heart model has an atrial septum as the septum and further includes either a right atrium or a left atrium, or both, and
the pulsatile pump is connected to the right atrium, the left atrium, or a space contiguous with the right atrium and the left atrium.

4. The catheter simulator according to claim 3, wherein the pulsatile pump continuously generates a negative pressure and a positive pressure within the right atrium or the left atrium by repeating an operation of suctioning the liquid and an operation of discharging the liquid.

5. The catheter simulator according to claim 3, wherein at least one of the right atrium and the left atrium of the heart model forms a closed circuit in a state of having the pulsatile pump connected.

6. The catheter simulator according to claim 3, wherein portions other than the atrial septum of the heart model are closed, and a substantially closed circuit is formed in a state of having the pulsatile pump connected thereto.

7. The catheter simulator according to claim 1, wherein the heart model has a ventricular septum as the septum and further includes either a right ventricle or a left ventricle, or both, and
the pulsatile pump is connected to the right ventricle, the left ventricle, or a space contiguous with the right ventricle and the left ventricle.

8. The catheter simulator according to claim 7, wherein the pulsatile pump continuously generates a negative pressure and a positive pressure within the right ventricle or within the left ventricle by repeating an operation of suctioning the liquid and an operation of discharging the liquid.

9. The catheter simulator according to claim 7, wherein at least one of the right ventricle and the left ventricle of the heart model forms a closed circuit in a state of having the pulsatile pump connected thereto.

10. The catheter simulator according to claim 7, wherein portions other than the ventricular septum of the heart model are closed, and a substantially closed circuit is formed in a state of having the pulsatile pump connected thereto.

11. The catheter simulator according to claim 1, wherein the pulsatile pump and the container are connected, and an air discharge path discharging accumulated air bubbles into the container is installed in the pulsatile pump.

12. The catheter simulator according to claim 11, wherein the air discharge path is a path independent of suction and discharge of a liquid.

13. A heart model for a catheter simulator, the heart model being formed from a flexible material and comprising:
an atrial septum or a ventricular septum; and
at least one cardiac chamber of a right atrium, a left atrium, a right ventricle, and a left ventricle,
wherein the cardiac chamber is formed as a substantially closed space, and
a portion of a structural part constituting the substantially closed space is configured to be thinner compared to other structural parts.

14. The heart model according to claim 13, wherein the portion formed to be thinner compared to other structural parts is an atrial septum or a ventricular septum.

15. The heart model according to claim 14, wherein at least a portion of the atrial septum or the ventricular septum is attachable and detachable.

16. The heart model according to claim 14, wherein an opening part is formed in the atrial septum or the ventricular septum, and
a portion of the opening part is covered by a thin film member.

17. The heart model according to claim 16, wherein the thin film member is formed from a material harder than the atrial septum or the ventricular septum and is held by a holder attachable to or detachable from a peripheral edge of the opening part.

18. The heart model according to claim 16, wherein the thin film member has a slack in a central part.

19. The heart model according to claim 14, wherein a cutout part exposing the atrial septum or the ventricular septum is formed.

20. The heart model according to claim 14, wherein the heart model has an esophagus installed in contact with a back surface of the heart model.
